(19) United States
(12) Patent Application Publication
(10) Pub. No.: US 2026/0131901 A1
(43) Pub. Date: May 14, 2026

(54) COOLING SYSTEM FOR AIRCRAFT, AND AN AIRCRAFT TAILCONE INCLUDING THE COOLING SYSTEM

(71) Applicant: AIRBUS OPERATIONS, S.L.U., Madrid (ES)

(72) Inventors: Alberto MOLINA PARGA, Madrid (ES); Alfonso TEJELO MANZANO, Madrid (ES); Antonio José RUIZ-RICO RUIZ, Madrid (ES)

(21) Appl. No.: 19/385,527

(22) Filed: Nov. 11, 2025

(30) Foreign Application Priority Data
Nov. 11, 2024 (EP) 24383227.6

(51) Int. Cl. B64D 33/10; B64C 1/06

(52) U.S. Cl. CPC B64D 33/10; B64C 1/0685

(57) ABSTRACT

A compact cooling system for an aircraft tailcone including a heat exchanger, and a fan located inside the heat exchanger. The cooling system integrates both the heat exchanger and the fan within the tailcone into a single, cohesive solution, for optimizing the available space and enhancing the overall efficiency of the cooling process. An aircraft tailcone is disclosed including the cooling system.

### CROSS REFERENCE TO RELATED APPLICATION

This application claims priority to European Patent Application Number EP24383227.6, filed November 11, 2024, the entire contents of which is hereby incorporated by reference.

### BACKGROUND

The present disclosure relates to cooling systems for aircraft, and more specifically, a cooling system for the tailcone of the aircraft.

Aviation industry always aims to reduce weight within the aircraft in order to have potential savings in fuel blocks. Besides, new technologies within aviation are more focused on electrical components which may require larger heat dissipation.

In this regard, thermal management systems (hereinafter referred to TMS) in aviation are critical for ensuring optimal performance and safety of the aircraft, particularly in modern high-performance aircraft where high power densities lead to significant heat generation. The management of this excess heat is vital, especially in components like avionics, power electronics, and various propulsion systems.

Due to the large amount of heat that needs to be rejected in case of installing a non-gas turbine auxiliary power plant (based on Fuel cell, Internal Combustion Engine, others) a high-performance heat dissipation device needs to be integrated within that area. Considering traditional solutions, the typical approach would have been to install a ram air channel to drive and maximize the air mass flow from the external atmosphere through an air-liquid heat exchanger including an axial fan to suck air to cover ground operations (no air speed energy can be considered).

As there is a limited space in the tailcone area, the efficiency and specific fuel consumption (hereinafter as SFC) of the full non-gas auxiliary power plant is key and the air flow required for an air-liquid heat exchanger is huge, this solution requires having the maximum heat exchange volume with a minimum power consumption.

Therefore, traditional solutions for plate heat exchangers and axial fans embedded in a ram air channel would lead to non-efficient coiling systems and bulky architectures which would lead to considerable weight penalties at aircraft level.

### SUMMARY

The disclosure contemplates providing a compact cooling system suitable to be installed in an aircraft tailcone. Another object of the invention is to provide an aircraft tailcone comprising said cooling system.

The present disclosure overcomes the aforementioned drawbacks by providing a compact cooling system suitable to be installed in an aircraft tailcone. The present disclosure also contemplates providing an aircraft tailcone comprising the cooling system.

The cooling system and the aircraft tailcone according to an exemplary embodiment are defined in the corresponding independent claims. The dependent claims are directed toward further features of the disclosure.

The cooling system of an exemplary embodiment includes a heat exchanger and a fan located inside the heat exchanger. Both the heat exchanger and the fan define corresponding longitudinal axes, such that the inner dimension perpendicular to the longitudinal axis of the heat exchanger is similar to the outer dimension perpendicular to the longitudinal axis of the fan.

Moreover, both the heat exchanger and the fan are installed such that they share the same longitudinal axial axis. In this way, the heat exchanger and the fan, form a compact system which can be positioned within the tailcone of an aircraft.

Thus, the compact cooling system described herein encompasses both the heat exchanger and the fan, providing an integrated solution within the tailcone of the aircraft. The cooling system of the invention optimizes the volume of the thermal management system (TMS). In this way, an overall reduction in weight is achieved, and consequently a substantial reduction in fuel consumption. In this way, it is possible to eliminate the traditional APU (Auxiliar Power Unit) in the tailcone of an aircraft, and to place the cooling system of the present disclosure in the space where a traditional APU would have been placed.

In an exemplary embodiment, the heat exchanger comprises micro-tubes. The micro-tubes technology used in the heat exchanger, increases heat transfer between air and coolant, thanks to a larger exchange surface area compared to plate heat exchangers. In other words, these micro-tubes exchangers are highly efficient due to their large heat transfer surface area relative to volume, which makes them well-suited for compact designs where weight and size are constraints, such as in aircraft. At this point, it is worth mentioning that microtubes heat exchangers have a lower air pressure drop compared with a plate heat exchanger. The heat transfer is due to the passage of cold outside air around the micro-tubes. The coolant heated by the aircraft systems flows through the micro-tubes.

In an exemplary embodiment, both the micro-tubes heat exchanger and the fan have a cylindrical configuration. This cylindrical arrangement increases the front surface compared with a planar arrangement for a similar volume. It should be clarified that the term “front surface” here refers to the first surface of the heat exchanger that is perpendicular to the direction of air flow. In other words, it is the surface that comprises the inside diameter of the heat exchanger and the height of the cylinder. This reduces the thickness, i.e. the distance between the internal and the external diameters of the cylindrical heat exchanger, and therefore the air side pressure drops through the heat exchanger. Thus, the larger the front surface is, the more heat transfer, the less thickness of the heat exchanger is needed. Consequently, the fan power required to boost the air through the heat exchanger decreases. It leads to a lower power consumption.

In an exemplary embodiment, the fan is a centrifugal radial fan. These fans work by drawing air in through an inlet and forcing it out radially, and more specifically making them effective in drawing air from the inner heat exchanger cavity with a minimum distortion compared with an axial fan, which is ideal for circulating air through heat exchangers or confined spaces within an aircraft.

Furthermore, it is foreseen that the fan can incorporate a control device that controls the fan speed depending on the mass flow of air required to dissipate a certain amount of heat. This control device is based on the heat load liquid inlet temperature. Thus, the control loop increases the fan speed if the inlet temperature of the heat load increases. This control device has to be dimensioned to the worst conditions, which will be in flight at maximum altitude (lower air density).

The sizing of both the heat exchanger and the fan will mainly depend on the thermal rejection requirements, as well as the available space in the tailcone for a given aircraft model.

Moreover, the present disclosure provides a compact system that integrates both the heat exchanger and the fan within the aircraft’s tailcone into a single, cohesive solution, which not only optimizes the available space but also enhances the overall efficiency of the cooling process. By utilizing the airflow generated by the fan in conjunction with the passive heat transfer facilitated by the micro-tube heat exchanger, the system offers a lightweight, space-efficient compact solution which is not currently available in the market, and that maximizes the efficiency of the system in reducing the fuel block of the aircraft.

According to an exemplary embodiment, the aircraft tailcone includes the compact cooling system described above.

In an exemplary embodiment of the aircraft tailcone, the tailcone includes a grid formed by a plurality of ventilation slots distributed along the surface of the aircraft tailcone. This grid on the tailcone surface boosts air from outside to the centrifugal radial fan and then from the tailcone to the outside. It should be noted that the cooling air comes from the grid or from an intake, depending on the air pressure drop requirements.

### BRIEF DESCRIPTION OF THE DRAWINGS

For an understanding of embodiments of the disclosure, reference is now made to the following description taken in conjunction with the accompanying drawings, in which:

FIG. 1 illustrates a cross-sectional view of an aircraft tailcone incorporating the cooling system in accordance with an exemplary embodiment.

FIG. 2 illustrates a perspective view of the cooling system in accordance with an exemplary embodiment.

FIG. 3 illustrates a side view of a tailcone of an aircraft incorporating the grid on an outer surface in accordance with an exemplary embodiment.

### DETAILED DESCRIPTION OF SOME EMBODIMENTS

Some embodiments will now be described with reference to the Figures.

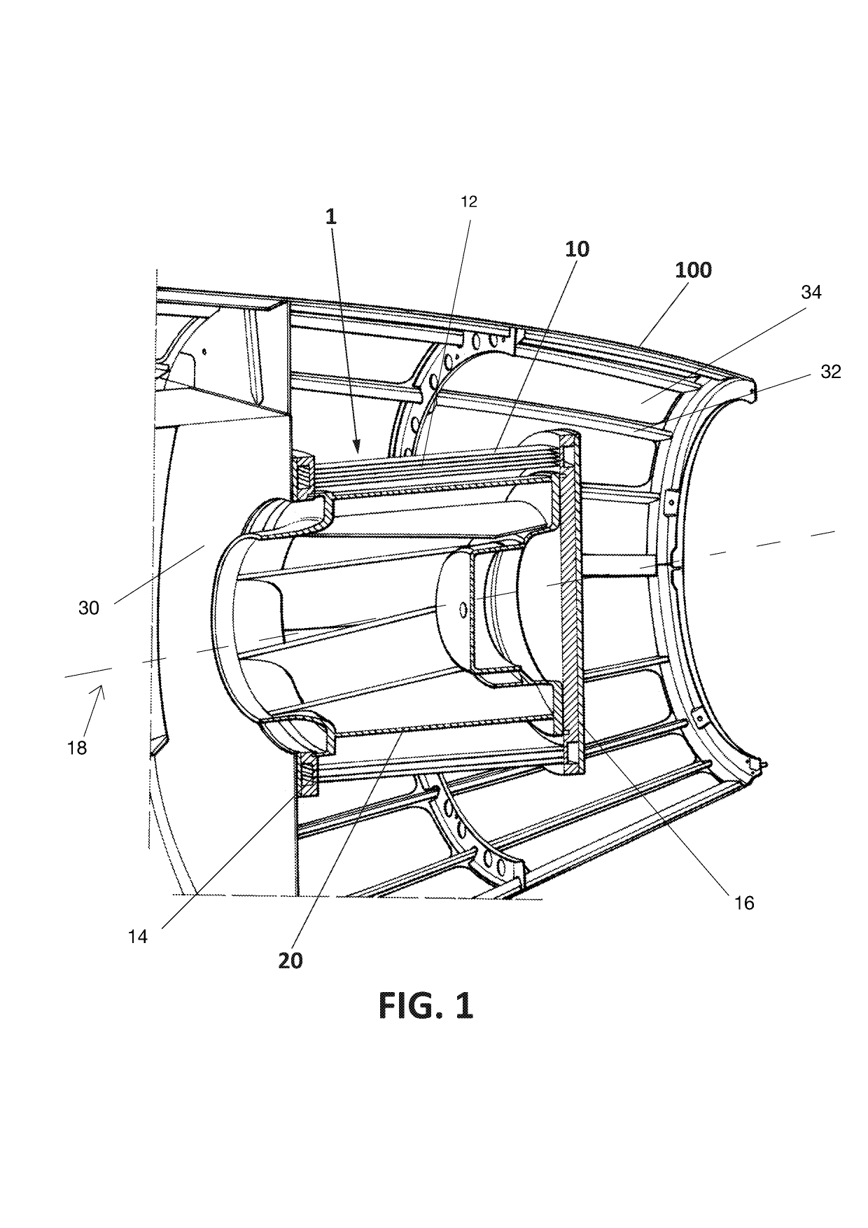

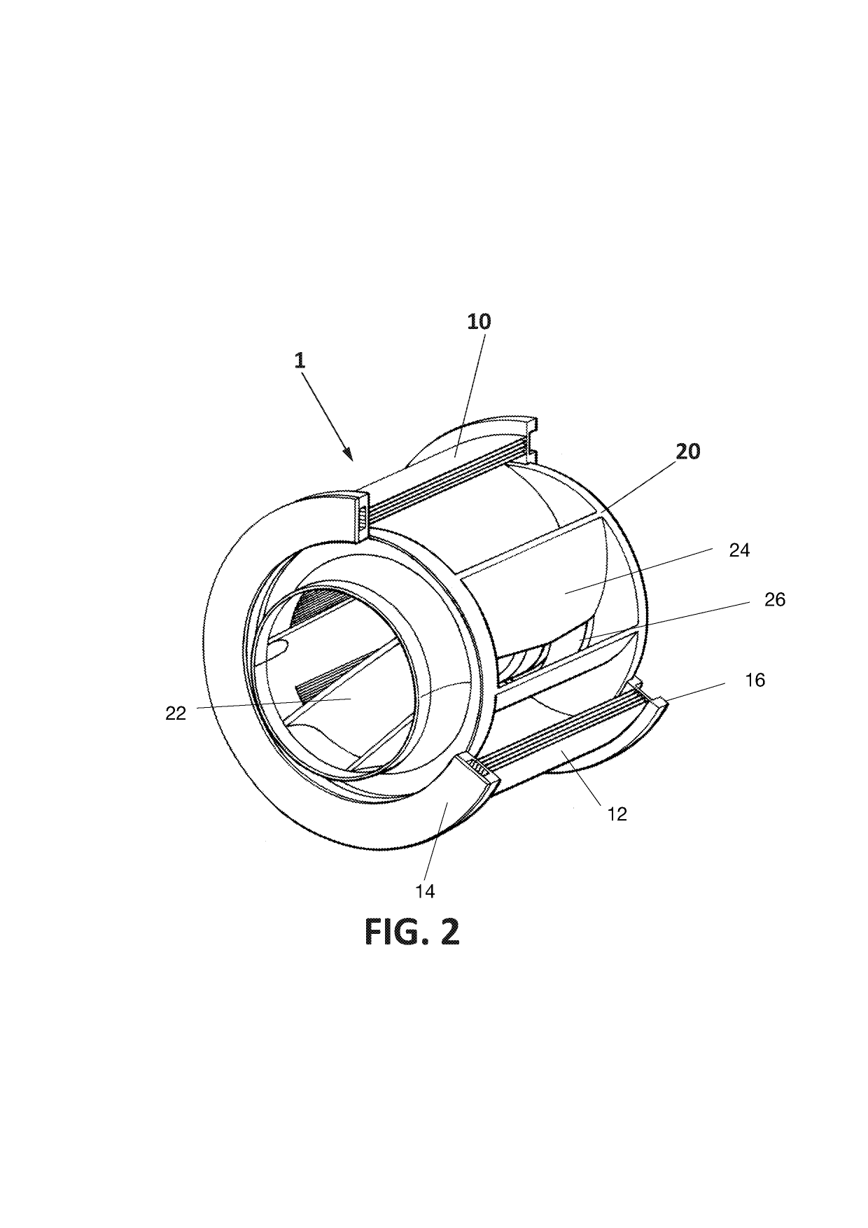

FIGS. 1 and 2 illustrate an exemplary embodiment of a cooling system 1 configured to be operably mounted within an aircraft tailcone 100. The cooling system 1 includes a micro-tubes heat exchanger 10, and a centrifugal radial fan 20 located inside the micro-tubes heat heat exchanger 10.

As best seen from FIGS. 1 and 2, the micro-tubes heat exchanger 10 includes a plurality of microtubes 12 extending between a first wall 14 and a second wall 16 the inner diameter of the heat exchanger 10 contacts with the outer diameter of the fan 20. That is, the inner transversal dimension of the heat exchanger 10 is similar to the outer transversal dimension of the centrifugal radial fan 20, and the centrifugal radial fan is bounded within the micro-tubes heat exchanger 10.

According to an exemplary embodiment, both the micro-tubes heat exchanger 10 and the centrifugal radial fan 20 may have a cylindrical configuration, and are installed such that they share the same longitudinal axial axis 18, in a horizontal orientation as, shown in FIGS. 1 and 2. This particular feature allows to increase the frontal surface area compared to a flat arrangement for a similar volume, reducing the thickness and thus the pressure drop on the air side through the heat exchanger, which ultimately results in a lower power consumption of the fan.

Furthermore, according to an exemplary embodiment, each of the plurality of microtubes 12 is arranged longitudinally parallel to the common longitudinal axis 18. This feature allows maximizing the above-mentioned advantageous effects, such as a larger heat transfer surface, higher thermal efficiency, and higher structural strength.

Therefore, both elements, the micro-tubes heat exchanger 10 and the centrifugal radial fan 20, form a compact system configured to be positioned within the tailcone 100 of an aircraft.

As shown in FIG. 2, centrifugal the radial fan 20 is located in the inner part of the integrated cooling system 1. The centrifugal the radial fan 20 includes an air inlet 24 a plurality of radially positioned fan blades 24 having an opening or gap 26 configured to draw air from the air inlet 24 and pushing and redirecting the air from the axial direction of the fan 20 to the plurality of the microtubes 12 of the micro-tubes heat exchanger 10.

The micro-tubes heat exchanger 10 is located in the outer part of the integrated cooling system 1. The inner diameter of the micro-tubes heat exchanger 10 is next to the outer diameter of the other component, the fan 20. As mentioned above, the micro-tubes heat exchanger 10 uses a micro-tubes technology which increases the heat transfer surface between the micro-tubes fluid and the cooling air.

The centrifugal radial fan 20 may include a control device 28 to control the fan speed depending on the mass flow of air required to dissipate a certain amount of heat.

As shown in FIG. 1, the two components of micro-tubes heat exchanger 10 and centrifugal radial fan 20 are operably mounted and installed in an aircraft tailcone 100. The aircraft tailcone 100 may include a plurality of frame segments 30 having the cross sectional shape of the fuselage, a plurality of stringers 32 extending longitudinal and bonded or fastened to the inside of the fuselage skin 34. The microtubes heat exchanger 10 may be secured to the frame segments 30.

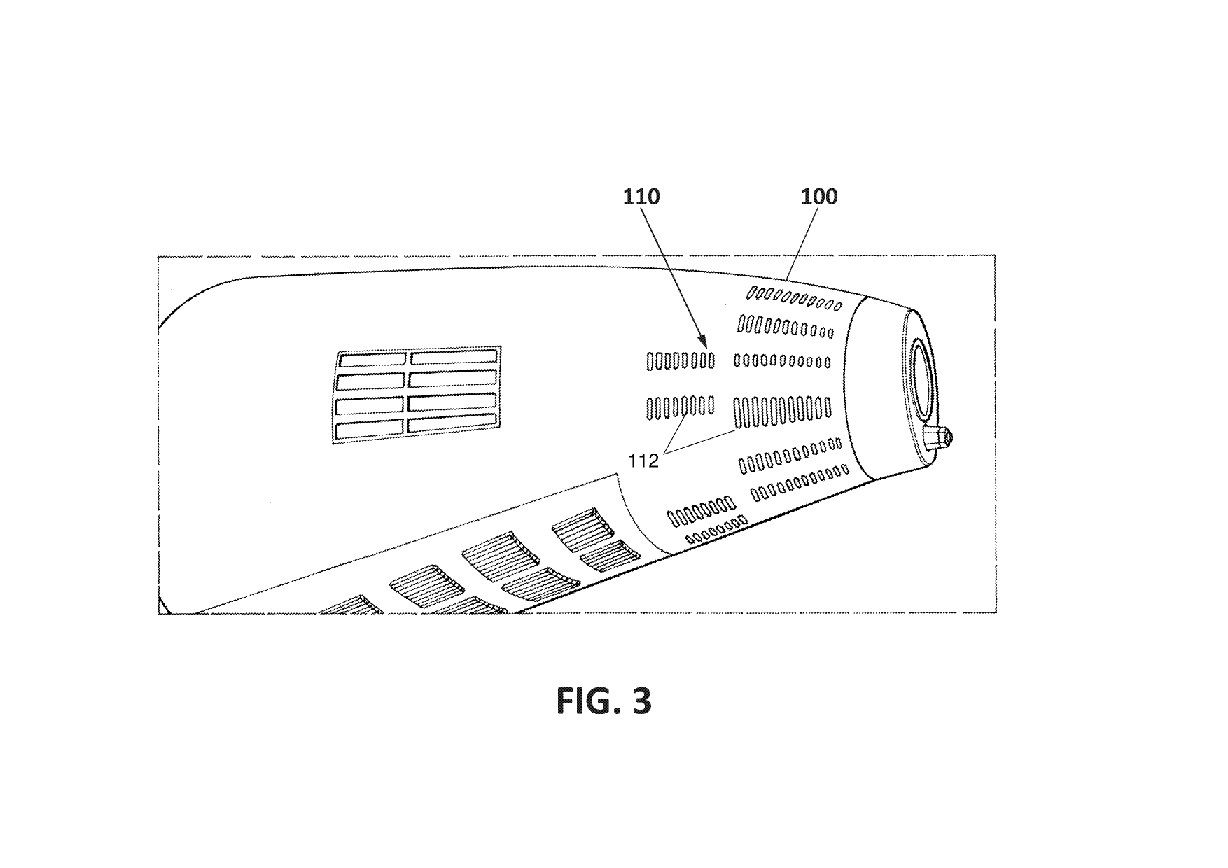

The centrifugal radial fan 20 drawing air from one compartment and expelling into another separated compartment. Referring to FIG. 3, the tailcone 100 includes a grid 110 having a plurality of ventilation slots 112 through the fuselage skin 34, which permit the external ambient air enter into the tailcone area and be sucked by the centrifugal radial fan 20, and then heated air from the micro-tubes heat exchanger 10 to outside.

As shown in FIG. 3, the plurality of ventilation slots 112 is distributed along the surface of the aircraft tailcone 100 in a vertically orientated configuration, but other orientations are contemplated to be within the scope of the present disclosure.

In the exemplary embodiment of FIG. 3, the ventilation slots 110 are arranged parallel to each other and oriented transversely and perpendicular to the longitudinal axial axis of the aircraft tailcone 100. This feature not only allows a better and more complete dissipation of the heat inside the tailcone 100, but also allows an improvement in aerodynamic stability, reducing turbulence, and a reduction of the internal pressure of the tailcone 100. An optimization of the structural weight without compromising the structural strength of the aircraft.

The heat dissipation is carried out as follows: The external ambient air enters into the tailcone 100 area through the plurality of the ventilation slots 112, passing the cooling system 1 through the air inlet 22 of the centrifugal radial the fan 20, the air passes between the plurality of microtubes 12 the micro-tubes heat exchanger 10 to cool the coolant circulating in the plurality of microtubes 12, and is ‘hot’ in the fuselage of the aircraft. Finally, this hot air exits out of the aircraft through the plurality of the ventilation slots 112 of the grid 110 on the surface of the tailcone 100.

Therefore, the cooling system 1 of the present disclosure combines the functionality of the cylindrical micro-tube heat exchanger 10 with the centrifugal radial fan 20 in a compact, efficient unit. This gap in the current state of the art has left room for innovation, especially in reducing the size and weight of thermal management systems (TMS) without compromising performance. The aerospace industry, constantly striving for lighter, more fuel-efficient aircraft, would greatly benefit from a solution that merges these components into a single system capable of both generating airflow and maximizing heat exchange in a confined space such as the tailcone 100 of an aircraft.

While at least one exemplary embodiment is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or "comprising" do not exclude other elements or steps, the terms "a" or "one" do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A cooling system for aircraft, comprising:
a heat exchanger bounding a space therewithin, and
a fan operably disposed inside the heat exchanger.

2. The cooling system according to claim 1, wherein both the heat exchanger and the fan define corresponding longitudinal axes, such that the inner dimension perpendicular to the longitudinal axis of the heat exchanger is similar to the outer dimension perpendicular to the longitudinal axis of the fan.

3. The cooling system according to claim 1, wherein both the heat exchanger and the fan are installed such that they share the same longitudinal axial axis.

4. The cooling system according to claim 1, wherein the heat exchanger is a micro-tubes heat exchanger.

5. The cooling system according to claim 4, wherein the micro-tubes heat exchanger further comprises a plurality of microtubes micro-tubes.

6. The cooling system according to claim 5, wherein each of the plurality of microtubes is arranged longitudinally relative to one another.

7. The cooling system according to claim 1, wherein both the heat exchanger and the fan have a cylindrical configuration.

8. The cooling system according to claim 1, wherein the fan is a centrifugal radial fan.

9. The cooling system according to claim 7, wherein the centrifugal radial fan includes an inlet and a plurality of radially extending blades.

10. The cooling system according to claim 1, wherein the fan comprises a control device configured to control a fan speed dependent on the mass flow of air required to dissipate a certain amount of heat.

11. An aircraft tailcone comprising the cooling system as claimed in claim 1.

12. The aircraft tailcone according to claim 9, further comprising a grid formed by a plurality of ventilation slots distributed along the surface of the aircraft tailcone.

13. An aircraft, comprising:
a tailcone bounding a space therewithin,
a cooling system disposed within the space of the tailcone,
the cooling system comprising
a micro-tubes heat exchanger having a first wall and a second wall, the microtubes heat exchanger comprising a plurality of microtubes extending between the first wall and the second wall, and
a centrifugal radial fan disposed within the micro-tubes heat exchanger, wherein the centrifugal radial fan includes a plurality of fan blades radially positioned along a central axis,
wherein the micro-tubes heat exchanger and the centrifugal radial fan are operably positioned along the central axis.
